(19) United States
(12) Patent Application Publication
(10) Pub. No.: US 2011/0265509 A1
(43) Pub. Date: Nov. 3, 2011

(54) MULTIPLE-WAY VALVE, SYSTEM FOR ALTERNATELY COOLING AND HEATING A REACTOR, AND ALSO SORPTION COOLING

(75) Inventor: Simon Franciscus Smeding, Leeuwarden (NL)

(73) Assignee: STICHTING ENERGIEONDERZOEK CENTRUM NEDERLAND

(21) Appl. No.: 13/127,409

(22) PCT Filed: Nov. 4, 2009
(86) PCT No.: PCT/NL09/50661

§ 371 Date: Jul. 19, 2011

(30) Foreign Application Priority Data
Nov. 4, 2008 (NL) 2002164

(51) Int. Cl. F25B 29/00; F16K 11/065; F25B 17/02

(52) U.S. Cl. 62/478; 165/64; 137/625.18

(57) ABSTRACT

A multiple-way valve comprises a housing (31) which is provided with a heat inlet (32) and a coolness inlet (33). The housing (31) has a discharge (34) and a supply (35) for returning to the multiple-way valve (30) liquid which has been discharged from the multiple-way valve (30). A first and second valve part (40, 44) are each movable between a first and a second position. The valve parts (40, 44) have a heat recovery position in which the coolness inlet (33) is in fluid connection to the discharge (34) via the second valve part (44), the heat inlet (32) is closed off by the first valve part (40) with respect to the discharge (34) and the supply (35) is in fluid connection to the heat outlet (36) via the first valve part (40) for letting through returned liquid from the supply (35) to the heat outlet (36).

The invention relates to a multiple-way valve, in particular for use in a sorption cooling system, heat being used in order to make cold.

In this application, the terms “warm”, “cool”, “cold”, “coolness” and “heat” are used to distinguish various components from one another. These terms are not restrictive with regard to temperature. For example, a “cool” can correspond to a high absolute temperature. It is also possible for “cool” to correspond to a higher temperature than “warm”. The same applies to the other terms.

An adsorption cooling system is generally known. This sorption cooling system has a reactor in which a sorbent with bound refrigerant is received. The reactor is connected to a condenser and an evaporator for forming a refrigerant circuit. The refrigerant is for example water, while the sorbent may be formed by silica gel. Silica gel is highly hygroscopic, i.e. attracts water. In the completely saturated state, silica gel can absorb approximately 35 percent by weight of water.

The reactor is a heat exchanger in which a heat exchange line of a coolant circuit is attached. The coolant circuit is connected to a heat source and a heat emitter via a lines system with stop valves. Thus, warm and cold liquid can be alternately supplied to the heat exchange line in the reactor. The heat source is for example residual heat.

The sorption cooling system carries out a batching process. Firstly, the silica gel with the bound water in the reactor is warmed up by warm liquid. The warm liquid originates from the heat source. During this warming-up, the pressure gradually increases until the water vapour tension above the silica gel is higher than the vapour tension at the condenser temperature. Subsequently, water vapour from the silica gel will flow to the condenser and continue to warm up the silica gel while emitting water vapour until the silica gel still contains just a small amount of water.

Subsequently, the temperature of the silica gel in the reactor is lowered by passing a cool liquid through the heat exchange line of the reactor. In this process, the pressure drops and water vapour originating from the evaporator is absorbed in the silica gel. Water vapour continues to be absorbed until the silica gel again contains an amount of bound water that corresponds to the beginning of the cycle. Afterwards, the silica gel can be warmed up again.

In this cycle, there is thus a heating phase in which the silica gel is regenerated and wherein no cold is produced. During the cooling-down phase of the silica gel, water vapour is drawn out of the evaporator and cold is made. For example, water flows through a heat exchange line of the evaporator, so that the temperature of the water decreases and cold water is produced.

The sorption cooling system is in fact driven by the rise in temperature of the refrigerant as a consequence of the rise in temperature of the sorbent. The term “thermal compression” is therefore used in order to indicate that the difference in pressure that is required in order to induce condensation and evaporation during sorption cooling is not provided by a mechanical compressor.

The lines system with stop valves in order to alternately pass warm and cool liquid through the heat exchange line of the reactor is very bulky and difficult to access for maintenance work. The high thermal mass thereof also entails heat loss. Furthermore, it is conventional to operate the valves in such a way that the supply of warm liquid is closed off at the same time as the opening of the supply of cool liquid. However, at that moment, the reactor still contains a significant amount of warm liquid which enters the coolant circuit. This causes additional heat loss and adversely influences the yield of the sorption cooling.

An object of the invention is to provide an improved multiple-way valve, in particular a multiple-way valve which is relatively compact and allows a relatively high yield during the alternate heating and cooling of a system.

According to the invention, this object is achieved by a multiple-way valve with a housing which is provided with:
a heat inlet for letting in a warm liquid,
a coolness inlet for letting in a cool liquid,
a discharge for discharging liquid that has been let in,
a supply for returning to the multiple-way valve liquid that has been discharged from the multiple-way valve via the discharge,
a heat outlet for letting out returned liquid,
a coolness outlet for letting out returned liquid,
a first valve part which is movable between a first position, in which the heat inlet is in fluid connection to the discharge for letting through warm liquid from the heat inlet to the discharge, and a second position in which the heat inlet is closed off with respect to the discharge,
a second valve part which is movable between a first position, in which the coolness inlet is in fluid connection to the discharge for letting through cool liquid from the coolness inlet to the discharge, and a second position in which the coolness inlet is closed off with respect to the discharge, the valve parts having a heat recovery position in which the coolness inlet is in fluid connection to the discharge via the second valve part for letting through cool liquid from the coolness inlet to the discharge, the heat inlet is closed off by the first valve part with respect to the discharge and the supply is in fluid connection to the heat outlet via the first valve part for letting through returned liquid from the supply to the heat outlet.

The multiple-way valve according to the invention is operative to alternately cool and heat a reactor, while the multiple-way valve is relatively compact as a result of the integrating of the inlets, outlets, supply and discharge in a housing. In the heat recovery position of the multiple-way valve, warm liquid which is still present in the heat exchange line of the reactor can be discharged therefrom via the supply and heat outlet of the multiple-way valve, while the heat exchange line is already fed with cooling water via the coolness inlet and discharge of the multiple-way valve. As a result, the warm liquid from the reactor first flows back to the heat source, so that mixing of warm liquid with cool liquid in the refrigerant circuit is reduced. As a result of the use of this multiple-way valve in a system which has to be alternately warmed up and cooled, this system has a relatively high yield.

In an embodiment, the valve parts are each provided with two through-channels, wherein, in the first position of the first valve part, the heat inlet and the discharge are connected by the first through-channel of the first valve part and the supply and the heat outlet are connected by the second through-channel of the first valve part and wherein, in the second position of the first valve part, the heat inlet and the heat outlet are closed off by the first valve part with respect to the supply and the discharge and wherein, in the first position of the second valve part, the coolness inlet and the discharge are connected by the first through-channel of the second valve part and the supply and the coolness outlet are connected by the second through-channel of the second valve part and wherein, in the second position of the second valve part, the coolness inlet and the coolness outlet are closed off by the second valve part with respect to the supply and the discharge and wherein, in the heat recovery position, the supply and the heat outlet are connected by the first through-channel of the first valve part and the heat inlet is closed off by the first valve part with respect to the discharge and wherein, in said heat recovery position, the coolness outlet is closed off by the second valve part with respect to the supply and the discharge and the coolness inlet are connected by the second through-channel of the second valve part. In this embodiment of the valve parts, the switching between the first position, second position and heat recovery position is simple and reliable. In particular, leakage losses via the through-channels cannot or can hardly occur.

When the through-channels are aligned with respect to one of the inlets and discharge or one of the outlets and supply, a fluid connection is formed. The valve parts can close off the fluid connection between the inlets and discharge and the fluid connection between the outlets and supply as a result of displacing of the valve parts, so that the through-channels are no longer aligned. When the through-channels of a valve part do not open out into an inlet, outlet, supply or discharge, the fluid connection is interrupted by that valve part.

According to the invention, it is preferable for the valve parts to have a second heat recovery position in which the heat inlet is in fluid connection to the discharge via the first valve part for letting through warm liquid from the heat inlet to the discharge, the coolness inlet is closed off by the second valve part with respect to the discharge and the supply is in fluid connection to the coolness outlet for letting through returned liquid from the supply to the coolness outlet.

The cooling of the reactor begins in the first heat recovery position, while it is recovered from the return flow of the reactor. The second heat recovery position is set during the switching from cooling to heating of the reactor. The return flow of cool liquid which is still present in the reactor then flows to the heat emitter, while warm liquid from the heat source is already flowing into the heat exchange line of the reactor. The second heat recovery position of the multiple-way valve reduces heat loss during the switching from cooling to heating.

In this case, it is possible for, in the second heat recovery position, the heat outlet to be closed off by the first valve part with respect to the supply and the discharge and the heat inlet to be connected by the second through-channel of the first valve part and, in said second heat recovery position, the supply and the coolness outlet to be connected by the first through-channel of the second valve part and the coolness inlet to be closed off by the second valve part with respect to the discharge. In the second heat recovery position, the through-channels are positioned so as to produce a fluid connection between the heat inlet and the discharge of the multiple-way valve and between the supply and the coolness outlet of the multiple-way valve.

In an embodiment, the valve parts are connected to each other in such a way that the first valve part has the first position when the second valve part has the second position and the first valve part has the second position when the second valve part has the first position. As a result, “short-circuiting” of the multiple-way valve is mechanically impossible, so that there is no chance of incorrect operation of the multiple-way valve. In the known lines system with stop valves and check valves, there is the risk that the stop valves will be positioned incorrectly as a result of a malfunction; this can lead to damage to the system.

In a preferred embodiment, the housing of the multiple-way valve is provided with a second discharge for discharging liquid that has been let in and a second supply for returning to the multiple-way valve liquid that has been discharged from the multiple-way valve via the second discharge, wherein, in the first position of the first valve, the heat inlet is closed off by the first valve part with respect to the second discharge and wherein, in the second position of the first valve part, the heat inlet is in fluid connection to the second discharge via the first valve part for letting through warm liquid from the heat inlet to the second discharge and wherein, in the first position of the second valve part, the coolness inlet is closed off by the second valve part with respect to the second discharge and wherein, in the second position of the second valve part, the coolness inlet is in fluid connection to the second discharge via the second valve part for letting through cool liquid from the coolness inlet to the second discharge.

In this case, the multiple-way valve is suitable for alternately heating and cooling two reactors of a system. On use in a sorption cooling system, there is in each reactor a heating phase in which the sorbent is regenerated and wherein no cold is produced. Cold is made merely when the silica gel in the reactors cools down and water vapour is drawn out of the evaporator. According to the invention, the two batches in the two reactors can be operated in phase opposition in order to continuously produce cold. When the first reactor makes cold, the sorbent in the second reactor is regenerated and subsequently the second reactor can make cold while the sorbent in the first reactor regenerates.

In a multiple-way valve for use in a system with a plurality of reactors, the housing can comprise a first dividing piece which divides the heat inlet into two heat inlet channels and divides the heat outlet into two heat outlet channels and wherein the housing comprises a second dividing piece which divides the coolness inlet into two coolness inlet channels and divides the coolness outlet into two coolness outlet channels. The warm liquid and cool liquid are separated in the dividing pieces into two separate warm and cool liquid flows which the valve parts can open and/or close off.

In this case, it is possible for, in the first position of the first valve part, the first heat inlet channel of the first dividing piece and the discharge to be connected by the first through-channel of the first valve part and the supply and the first heat outlet channel of the first dividing piece to be connected by the second through-channel of the first valve part and the second heat inlet channel and the second heat outlet channel of the first dividing piece to be closed off by the first valve part and wherein, in the second position of the first valve part, the second heat inlet channel of the first dividing piece and the second discharge are connected by the first through-channel of the first valve part and the second supply and the second heat outlet channel of the first dividing piece are connected by the second through-channel of the first valve part and the first heat inlet channel and the first heat outlet channel of the first dividing piece are closed off by the first valve part and wherein, in the first position of the second valve part, the first coolness inlet channel of the second dividing piece and the discharge are connected by the first through-channel of the second valve part and the supply and the first coolness outlet channel of the second dividing piece are connected by the second through-channel of the second valve part and the second coolness inlet channel and the second coolness outlet channel of the second dividing piece are closed off by the second valve part and wherein, in the second position of the second valve part, the second coolness inlet channel of the second dividing piece and the second discharge are connected by the first through-channel of the second valve part and the second supply and the second coolness outlet channel of the second dividing piece are connected by the second through-channel of the second valve part and the first coolness inlet channel and the first coolness outlet channel of the second dividing piece are closed off by the second valve part and wherein, in the heat recovery position, the supply and the first heat outlet channel of the first dividing piece are connected by the first through-channel of the first valve part and the second heat inlet channel of the first dividing piece and the second discharge are connected by the second through-channel of the first valve part and, in said heat recovery position, the second supply and the second coolness outlet channel of the second dividing piece are connected by the first through-channel of the second valve part and the discharge and the first coolness inlet channel of the second dividing piece are connected by the second through-channel of the second valve part.

In that case, it is possible for, in the second heat recovery position, the second supply and the second heat outlet channel of the first dividing piece to be connected by the first through-channel of the first valve part and the first heat inlet channel of the first dividing piece and the supply to be connected by the second through-channel of the first valve part and, in said second heat recovery position, the supply and the first coolness outlet channel of the second dividing piece to be connected by the first through-channel of the second valve part and the second supply and the second coolness inlet channel of the second dividing piece to be connected by the second through-channel of the second valve part.

In an embodiment, the housing of the multiple-way valve is provided with a third discharge for discharging liquid that has been let in and a third supply for returning to the multiple-way valve liquid that has been discharged from the multiple-way valve via the third discharge and a fourth discharge for discharging liquid that has been let in and a fourth supply for returning to the multiple-way valve liquid that has been discharged from the multiple-way valve via the fourth discharge and wherein, in the first and second position of the first valve part, the heat inlet is closed off by the first valve part with respect to the third discharge and the fourth discharge and wherein, in the first and second position of the second valve part, the coolness inlet is closed off by the second valve part with respect to the third discharge and the fourth discharge and wherein the first valve part has a third position in which the heat inlet is in fluid connection to the third discharge via the first valve part for letting through warm liquid from the heat inlet to the third discharge and wherein the first valve part has a fourth position in which the heat inlet is in fluid connection to the fourth discharge via the first valve part for letting through warm liquid from the heat inlet to the fourth discharge and wherein the second valve part has a third position in which the coolness inlet is in fluid connection to the third discharge via the second valve part for letting through cool liquid from the coolness inlet to the third discharge and wherein the second valve part has a fourth position in which the coolness inlet is in fluid connection to the fourth discharge via the second valve part for letting through cool liquid from the coolness inlet to the fourth discharge and wherein the housing of the multiple-way valve is provided with a third valve part which is movable between a first position, in which the supply is in fluid connection to the third discharge via the third valve part and the second supply is in fluid connection to the fourth discharge via the third valve part, and a second position, in which the fourth supply is in fluid connection to the discharge via the third valve part and the third supply is in fluid connection to the second discharge via the third valve part, and a first heat recovery position, in which the fourth discharge is in fluid connection to the fourth supply via the third valve part and the third discharge is in fluid connection to the third supply via the third valve part, and a second heat recovery position in which the discharge is in fluid connection to the supply via the third valve part and the second discharge is in fluid connection to the second supply via the third valve part.

As a result, the multiple-way valve is particularly suitable for use in a system with four reactors. The positions of the three valve parts are fixed with respect to one another. When the first valve part is in the first or second position and the second valve part has the second or first position respectively, the third valve part is in the first position. When the first valve part is in the third or fourth position and the second valve part has the fourth or third position respectively, the third valve part is in the second position. In the first heat recovery position of the third valve part, the two other valve parts are also in the first heat recovery position, while the third valve part has the second heat recovery position when the two other valve parts assume the second heat recovery position.

While heating of the first reactor and cooling of the second reactor are taking place, the third reactor is preheated and the fourth reactor is precooled—in the first position of the first valve part, the second position of the second valve part and the first position of the third valve part. For this purpose, warm liquid flows from the first reactor to the heat outlet not directly, but via the third valve part and the third reactor. At the same time, cool liquid is passed from the second reactor through the third valve part to the fourth reactor. This cool liquid subsequently flows from the fourth reactor to the coolness outlet. The displacing of the valve parts allows the first reactor to be successively heated, precooled, cooled and preheated. The same applies to the other reactors.

In this case, it is possible for the first dividing piece to divide the heat inlet into four heat inlet channels and to divide the heat outlet into four heat outlet channels, while the second dividing piece divides the coolness inlet into four coolness inlet channels and divides the coolness outlet into four coolness outlet channels. The first valve part has two through-channels which can be, as a result of the displacing of that valve part, in fluid connection to one of the heat inlet channels and/or heat outlet channels or can close off these channels. The second valve part also has two through-channels which can be, as a result of the displacing of that valve part, in fluid connection to one of the coolness inlet channels and/or coolness outlet channels or can close off these channels. The third valve part has four through-channels and two conduits. The through-channels of the third valve part can be aligned with, in each case, one of the supplies or discharges. The two conduits each correspond to one of the supplies and one of the discharges.

In an embodiment, the valve parts are attached within the housing of the multiple-way valve so as to be rotatable with respect to an axis of rotation. The valve parts are, for example, fastened to a common drive shaft which can be driven by a stepping motor. This makes the operation of the valves reliable.

The invention also relates to a system for alternately cooling and heating a reactor, comprising a reactor with an inlet and an outlet, a heat source, a heat emitter and also a multiple-way valve as described hereinbefore, wherein the heat inlet and the heat outlet of the multiple-way valve are connected to the heat source and wherein the coolness inlet and coolness outlet of the multiple-way valve are connected to the heat emitter and wherein the discharge of the multiple-way valve is connected to the inlet of the reactor and the outlet of the reactor is connected to the supply of the multiple-way valve. Various uses of this system are possible; for example, the system is suitable for carrying out a cooling process, chemical batching process or food product batching process.

In an embodiment, the multiple-way valve is embodied with a second supply as described hereinbefore and a second reactor with an inlet and an outlet is provided and wherein the second discharge of the multiple-way valve is connected to the inlet of the second reactor and the outlet of the second reactor is connected to the second supply of the multiple-way valve. In this system, two reactors can be operated in phase opposition in order to make the hatching processes continuous.

In addition, the invention relates to a sorption cooling system comprising:
a multiple-way valve as described hereinbefore,
a reactor with a sorbent and a refrigerant, which reactor is provided with a supply for vaporous refrigerant, a discharge for vaporous refrigerant, an inlet, an outlet and a heat exchange line extending through the sorbent and the refrigerant in the reactor from the inlet to the outlet of the reactor, wherein the discharge of the multiple-way valve is connected to the inlet of the reactor and the outlet of the reactor is connected to the supply of the multiple-way valve,
a condenser which is provided with a supply for vaporous refrigerant that is connected to the discharge of the reactor, a discharge for refrigerant condensed in the condenser, an inlet for cool water, an outlet for cool water and a heat exchange line extending in the condenser from the inlet to the outlet of the condenser, the outlet for cool water of the condenser being connected to the coolness inlet of the multiple-way valve,
an evaporator which is provided with a supply for liquid refrigerant that is connected to the discharge of the condenser, a discharge for refrigerant evaporated in the evaporator that is connected to the supply of the reactor, an inlet for cold water, an outlet for cold water and a heat exchange line extending in the evaporator from the inlet to the outlet of the evaporator,
a heat source which is connected to the heat inlet and the heat outlet of the multiple-way valve,
a heat emitter which is connected to the coolness outlet of the multiple-way valve and to the inlet for cool water of the condenser.

In order to make the production of cold by the sorption cooling system continuous, the multiple-way valve can be embodied with a second supply as described hereinbefore and wherein the sorption cooling system is provided with a second reactor with a sorbent and a refrigerant, which second reactor is provided with a supply for vaporous refrigerant, a discharge for vaporous refrigerant, an inlet, an outlet and a heat exchange line extending through the sorbent and the refrigerant in the second reactor from the inlet to the outlet of said second reactor, the second discharge of the multiple-way valve being connected to the inlet of the second reactor and the outlet of the second reactor being connected to the second supply of the multiple-way valve, the condenser being provided with a second supply for vaporous refrigerant that is connected to the discharge of the second reactor, a second discharge for refrigerant condensed in the condenser, the evaporator being provided with a second supply for liquid refrigerant that is connected to the second discharge of the condenser, a second discharge for refrigerant evaporated in the evaporator that is connected to the supply of the second reactor.

The invention will now be explained in greater detail with reference to the enclosed drawings, in which:

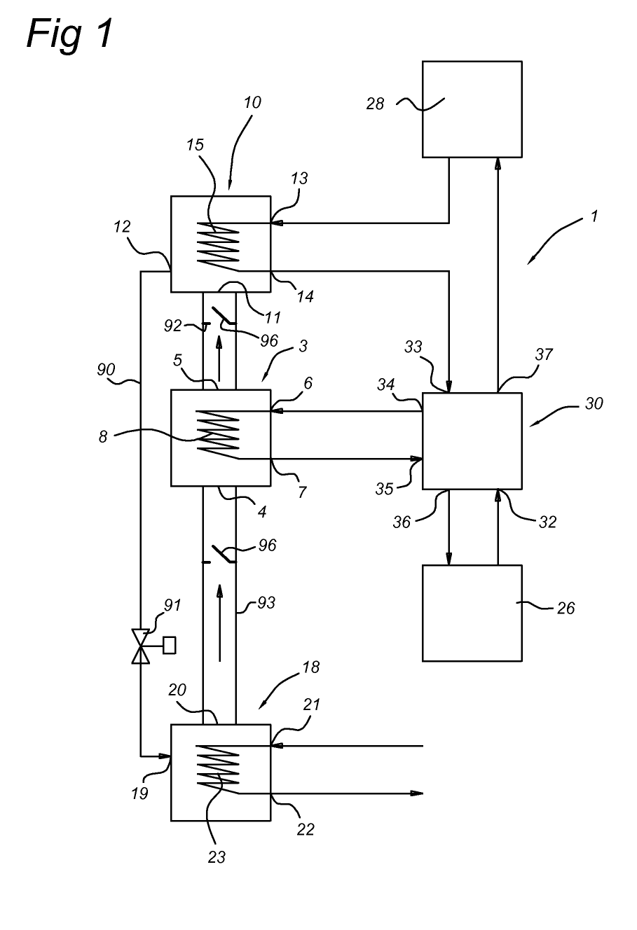

FIG. 1 is a process diagram of a first embodiment of a sorption cooling system according to the invention;

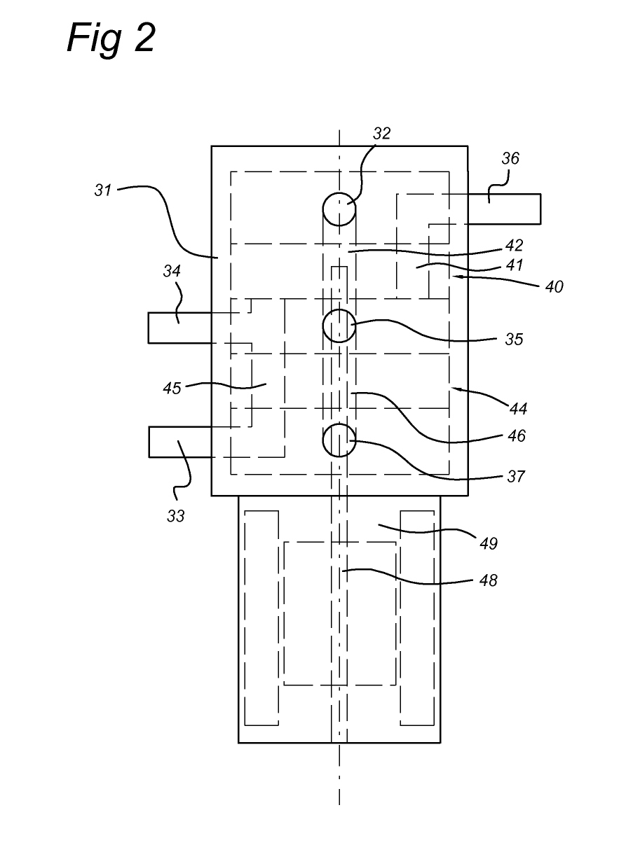

FIG. 2 shows schematically a first embodiment of a multiple-way valve;

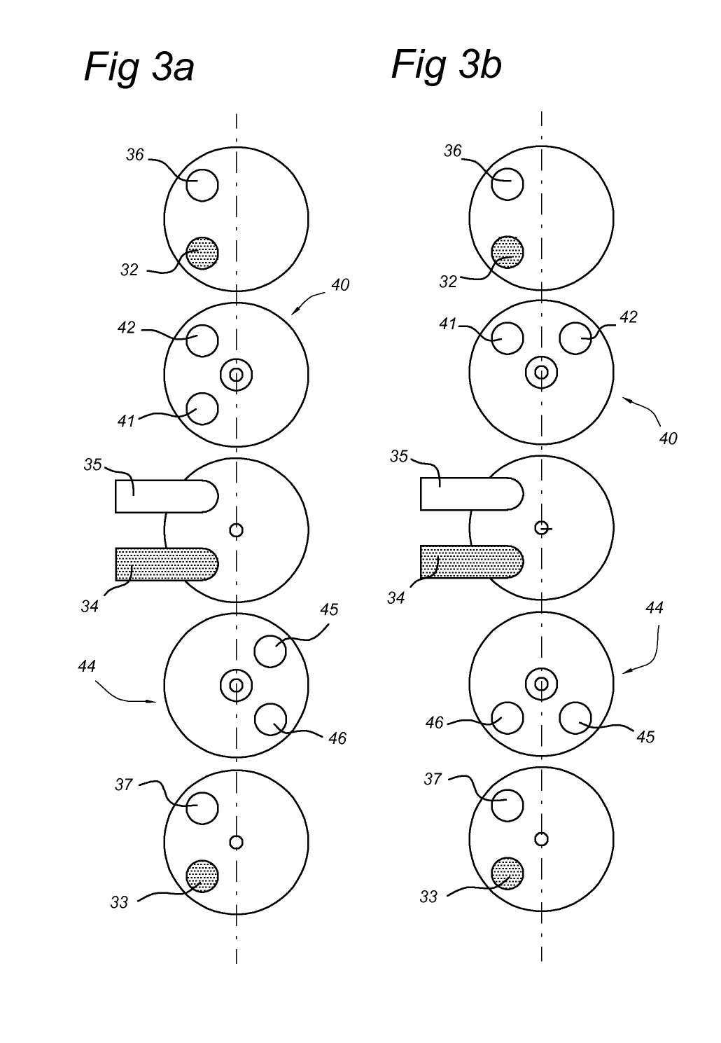

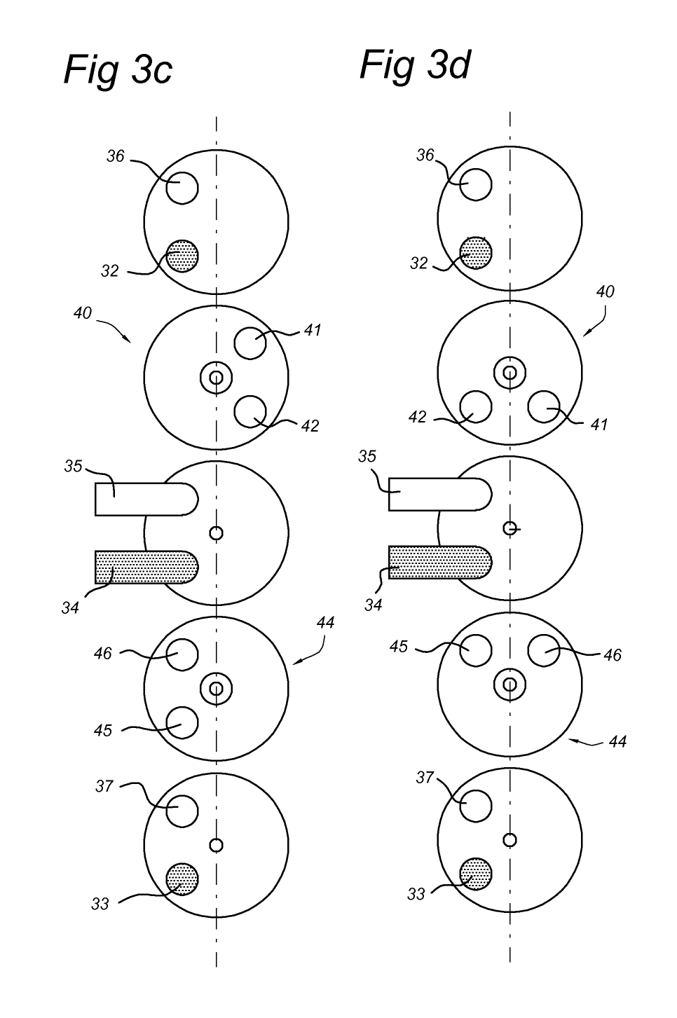

FIGS. 3a-d show schematically various positions of the multiple-way valve represented in FIG. 2;

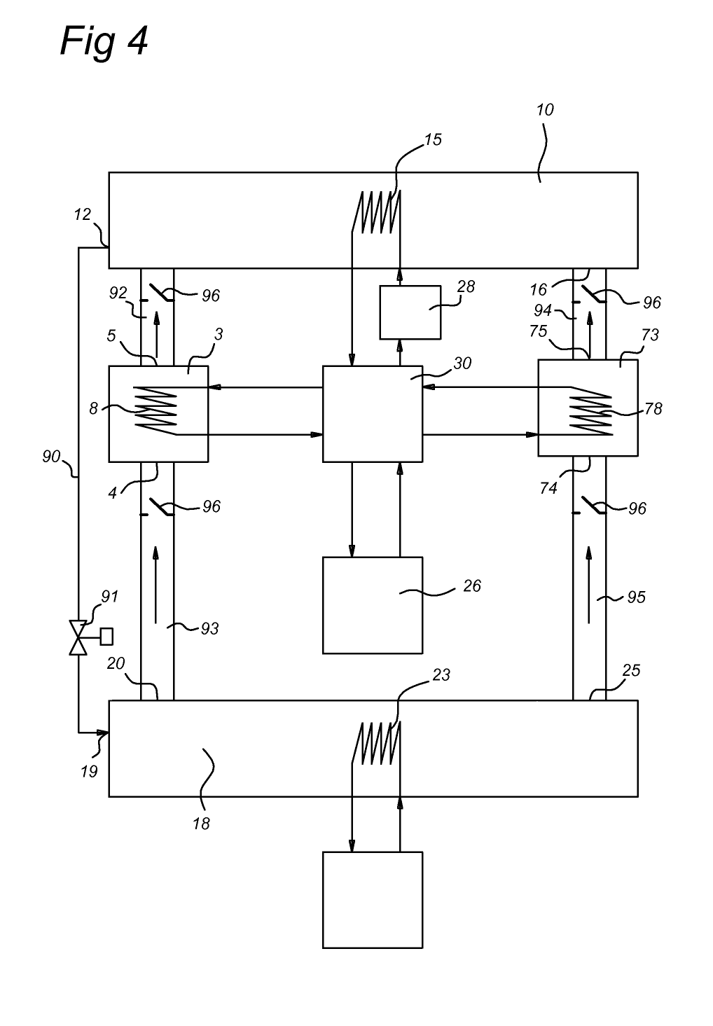

FIG. 4 is a process diagram of a second embodiment of a sorption cooling system according to the invention;

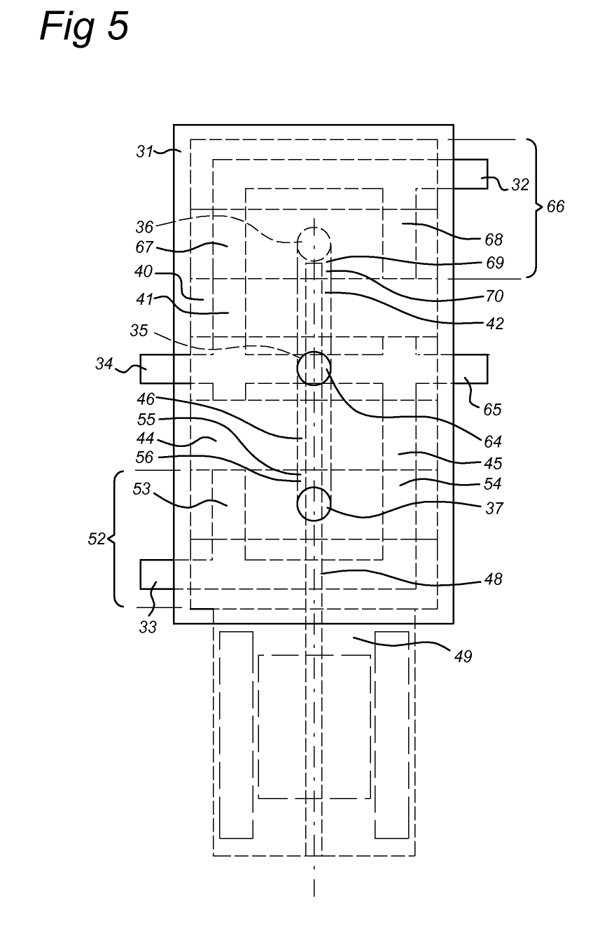

FIG. 5 shows schematically a second embodiment of a multiple-way valve;

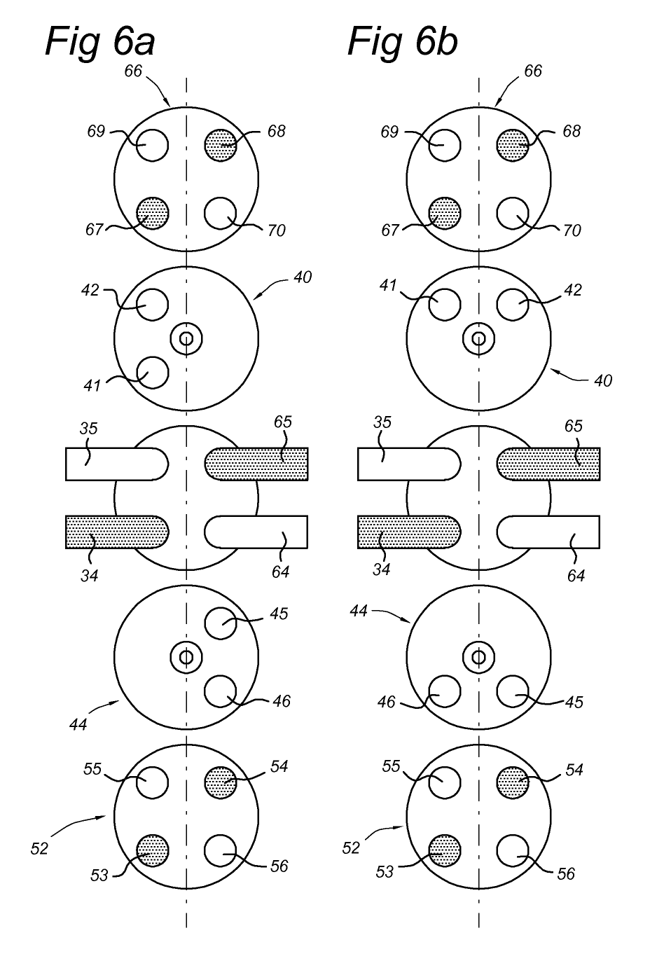

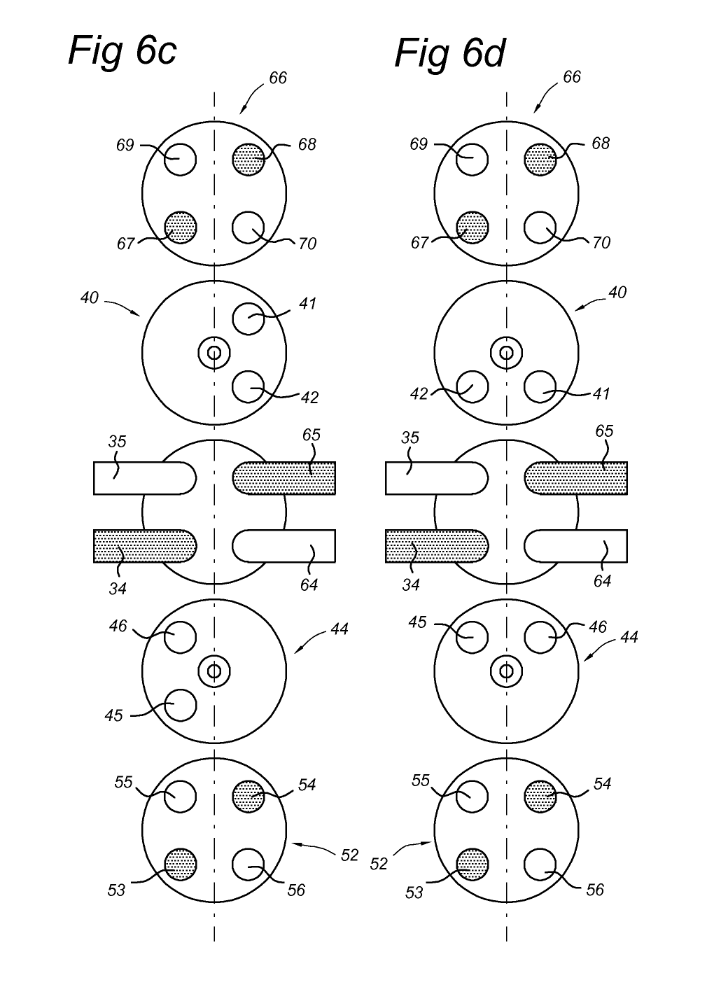

FIGS. 6a-d show schematically various positions of the multiple-way valve represented in FIG. 5;

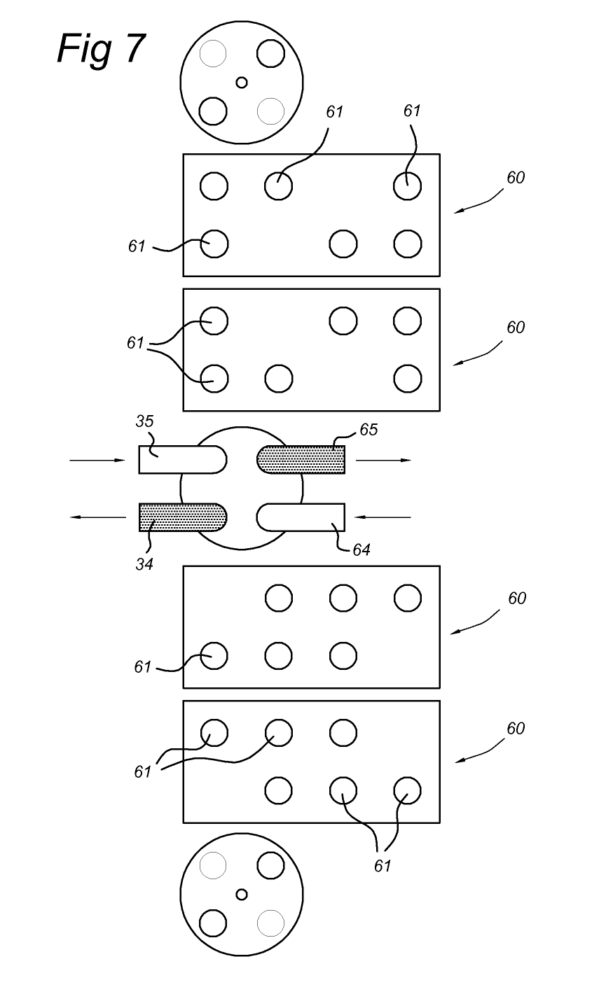

FIG. 7 shows schematically a third embodiment of a multiple-way valve;

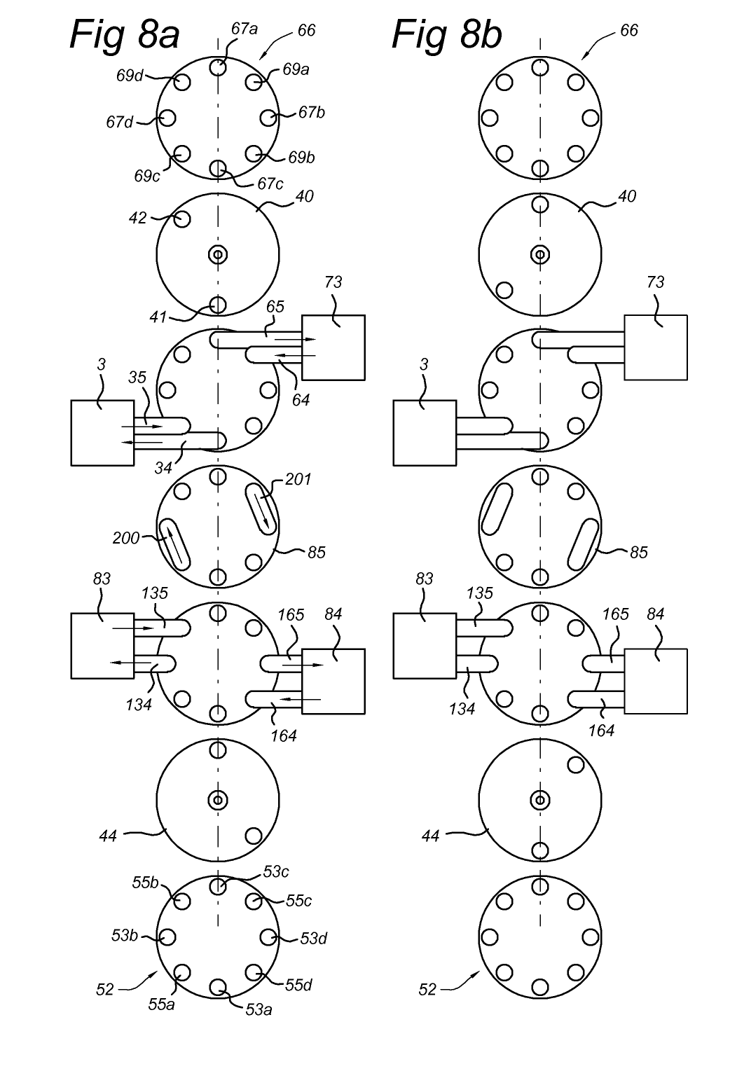

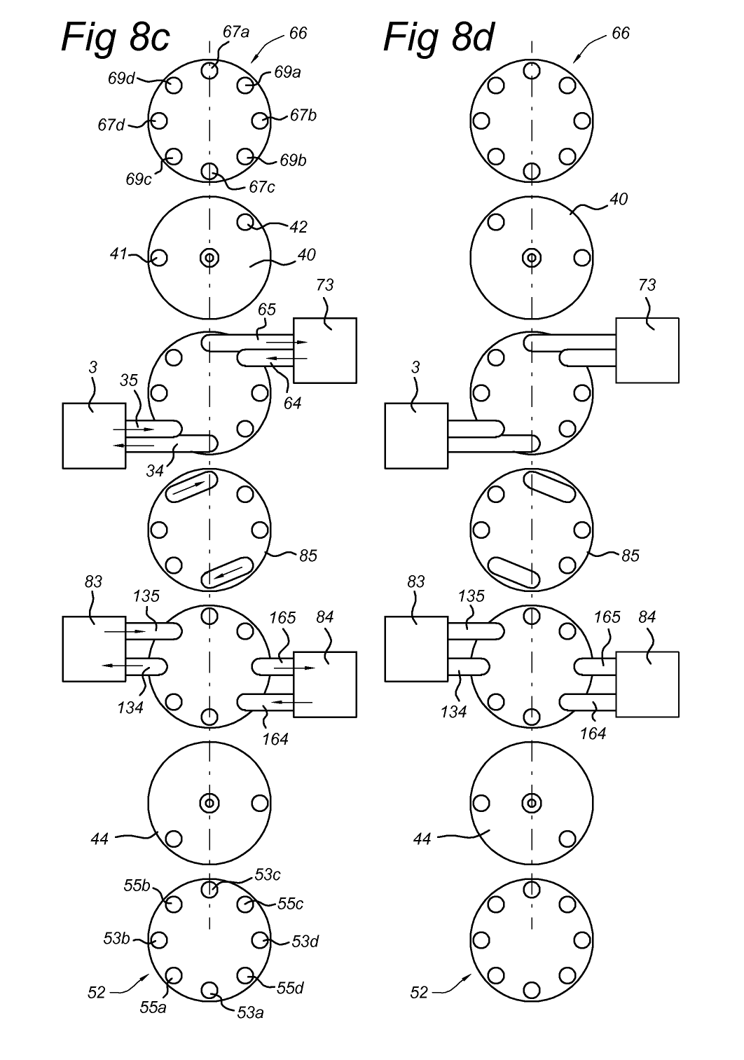

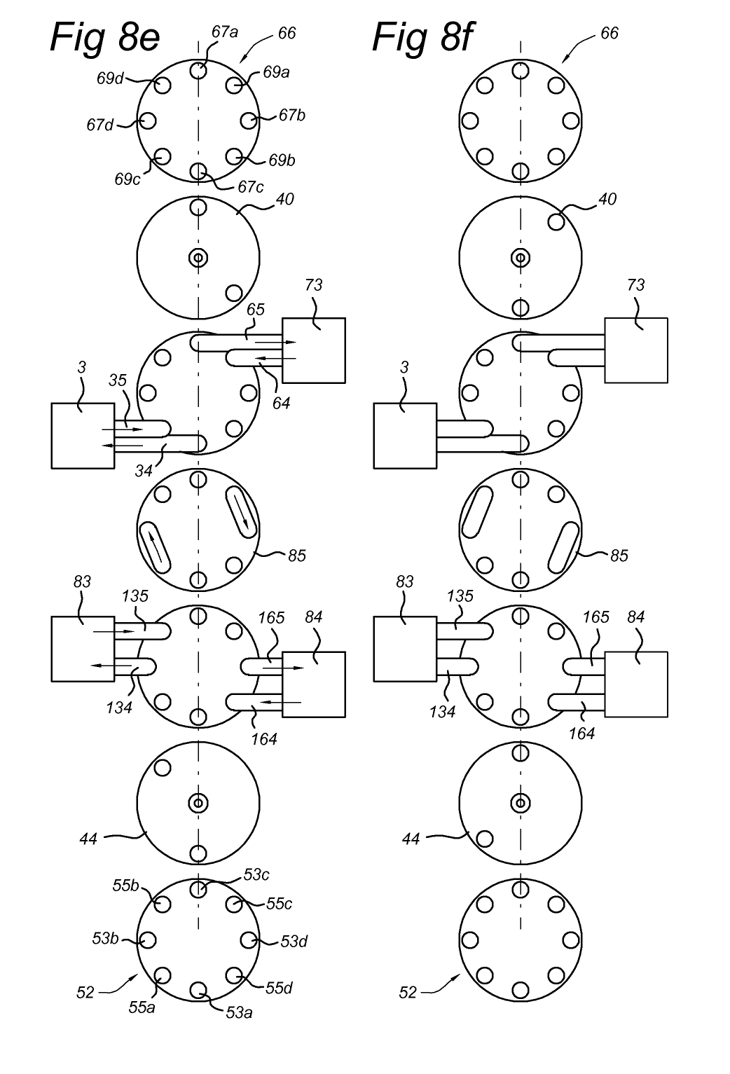

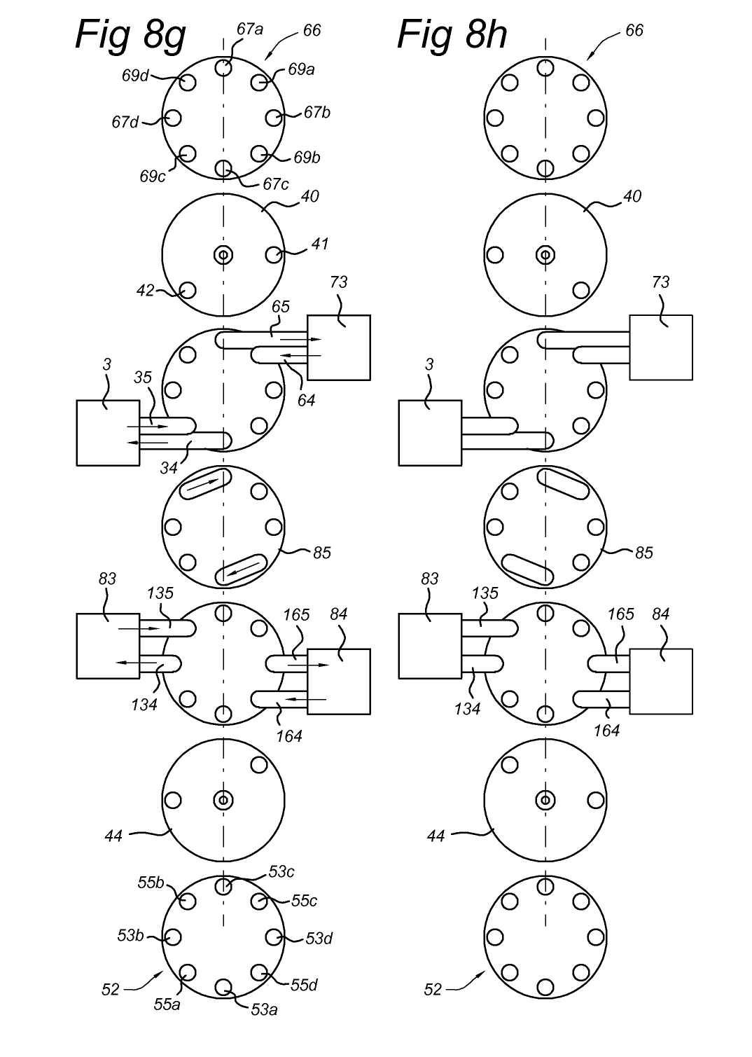

FIGS. 8a-h show schematically various positions of a fourth embodiment of a multiple-way valve;

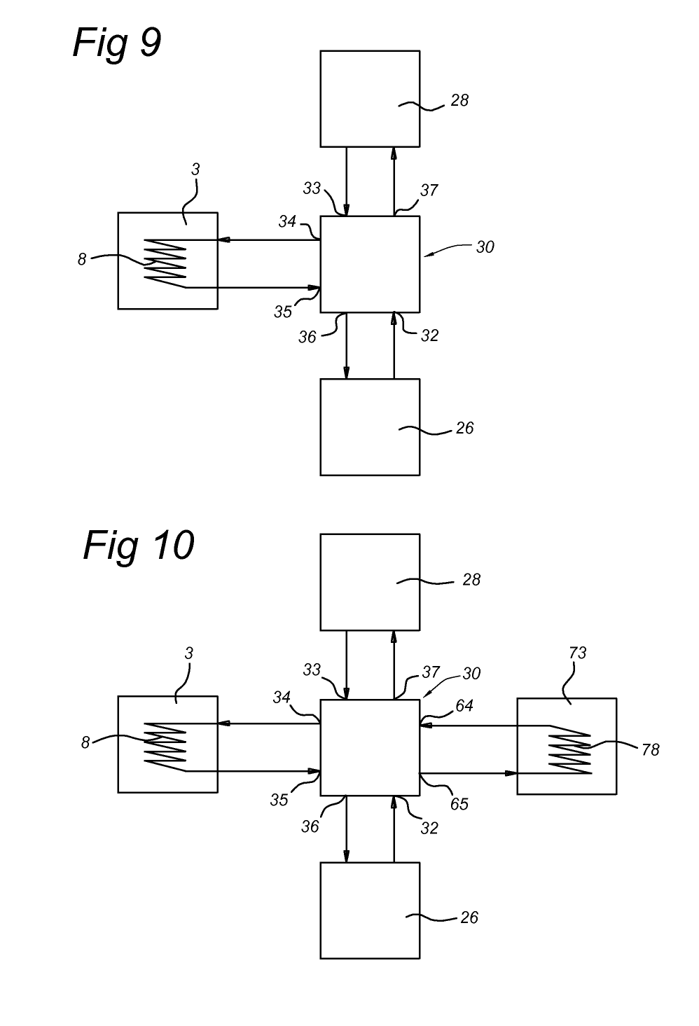

FIG. 9 is a process diagram of a system for alternately cooling and heating a reactor;

FIG. 10 is a process diagram of a system for alternately cooling and heating two reactors; and

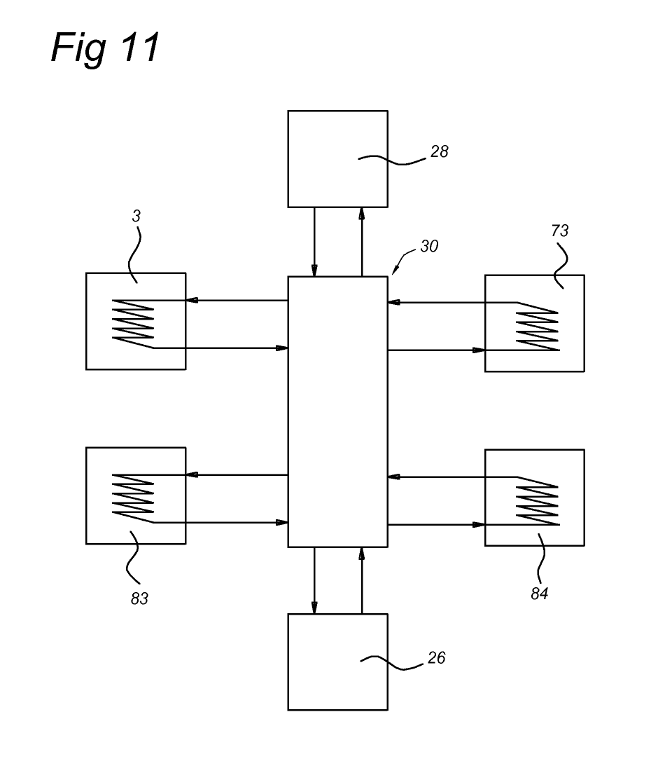

FIG. 11 is a process diagram of a system for alternately cooling and heating four reactors.

The sorption cooling system 1 shown in FIG. 1 comprises a reactor 3, a condenser 10, an evaporator 18, a heat source 26, a heat emitter at 28 and a multiple-way valve 30. The sorption cooling system 1 uses heat from the heat source 26 in order to make cold.

A sorbent with bound refrigerant is received in the reactor 3. In this exemplary embodiment, the sorbent is silica gel and the refrigerant is water. Silica gel is highly hygroscopic, i.e. attracts water. In the completely saturated state, silica gel can absorb approximately 35% by weight of water. Other combinations of sorbent and refrigerant are also possible. The reactor 3 has a supply 4 for supplying water vapour from the evaporator 18 and a discharge 5 for discharging water vapour to the condenser 10. A heat exchange line 8 extends through the silica gel with bound water in the reactor 3. The heat exchange line 8 runs from an inlet 6 to an outlet 7 of the reactor 3.

The condenser 10 comprises a supply 11 for supplying water vapour from the reactor 3. The discharge 5 of the reactor 3 and the supply 11 of the condenser 10 are connected to each other by a vapour channel 92. A vapour valve 96, which prevents water vapour from flowing back from the condenser 10 to the reactor 3, is attached in the vapour channel 92. The condenser 10 is provided with a heat exchange line 15 for conveying cool liquid, such as cooling water. The heat exchange line 15 extends from an inlet 13 through the condenser 10 to an outlet 14. In the condenser 10, the supplied water vapour condenses, after which the water (condensate) leaves the condenser 10 via a discharge 12.

The discharge 12 of the condenser 10 is connected to a supply 19 of the evaporator 18 via a return line 90. A condensate valve 91 is attached in the return line 90 in order to maintain the difference in pressure between the evaporator 18 and the condenser 10. The evaporator 18 comprises a heat exchange line 23 extending from an inlet 21 to an outlet 22. A fluid, such as water, which transfers heat to the water (condensate) supplied via the supply 19, flows through the heat exchange line 23. This produces water vapour which leaves the evaporator 18 via a discharge 20. The water vapour flows back to the supply 4 of the reactor 3 via a vapour channel 93. A vapour valve 96, which prevents water vapour from being able to flow back from the reactor 3 to the evaporator 18, is attached in the vapour channel 93 between the discharge 20 of the evaporator 18 and the supply 4 of the reactor 3. In the sorption cooling system 1, the refrigerant—in this exemplary embodiment water/water vapour—circulates in a refrigerant circuit.

The cooling using the sorption cooling system 1 operates in accordance with a batching process—the reactor 3 is embodied for alternately carrying out adsorption and desorption of the sorbent in the reactor 3. Firstly, the silica gel in the reactor 3 contains, for example, approximately 10 percent of bound water, while the temperature is approximately 30° C. Since the refrigerant circuit contains no gases other than the water vapour, the pressure is caused by the water vapour tension. Warming up the silica gel causes the pressure to gradually increase until the water vapour tension above the silica gel is higher than the vapour tension at the temperature in the condenser 10. The pressure in the reactor 3 rises for example to 60 mbar, while the pressure in the condenser 10 is 50 mbar. Water vapour from the silica gel will now flow to the condenser 10 and continue to warm up the silica gel in the reactor 3 while emitting water vapour (desorption).

When the silica gel contains for example just 3 percent of bound water, the silica gel is subsequently cooled down. The pressure drops in this case to a pressure which is lower than the pressure in the evaporator 18. Water vapour originating from the evaporator 10 flows through the vapour channel 93 to the reactor 3 and is absorbed in the silica gel (adsorption). Water continues to be absorbed until the silica gel has again, for example, approximately 10 percent of bound water at a temperature of approximately 30° C.

In the sorption cooling system 1 according to FIG. 1, in the cooling-down phase of the silica gel in the reactor 3, water vapour is drawn out of the evaporator 18 and the water (condensate) supplied via the supply 19 evaporates in the evaporator 18. In this case, heat is withdrawn from the cold fluid flowing through the heat exchange line 23 of the evaporator, i.e. the temperature of the cold fluid falls. The temperature of the cold fluid is below the ambient temperature, for example between 5 and 15° C., such as 10° C. The cold fluid, such as cold water, forms the cold product of the sorption cooling system 1.

A coolant circuit is provided to alternately cool and heat the reactor 3 with the silica gel and water bound thereto. The coolant circuit comprises the multiple-way valve 30, the heat source 26 and the heat emitter 28. The multiple-way valve 30 is represented in greater detail in FIGS. 2 and 3a-d.

The multiple-way valve 30 comprises a housing 31 which is provided with a heat inlet 32 and a heat outlet 36. The heat inlet 32 and the heat outlet 36 are each connected to the heat source 26. The heat source 26 is for example residual heat. The housing 31 has a coolness inlet 33 for letting in cooling water and a coolness outlet 37 which is connected to the heat emitter 28. The housing 31 has a discharge 34 which is connected to the supply 6 of the reactor 3. The housing 31 comprises a supply 35 which is connected to the discharge 7 of the reactor 3. Water flows from the discharge 34 of the multiple-way valve 30 through the heat exchange line 8 of the reactor 3 and back again to the supply 35 of the multiple-way valve 30.

Two valve parts 40, 44 are attached in the housing 31. Each valve part 40, 44 is provided with two through-channels 41, 42 and 45, 46 respectively. The valve parts 40, 44 are fastened to a drive shaft 48 which can be driven by a stepping motor 49. This allows the valve parts 40, 44 to be displaced between various positions.

In FIG. 3a, the first valve part 40 has a first position in which the heat inlet 32 is connected to the discharge 34 of the multiple-way valve 30 via the first through-channel 41. At the same time, the second through-channel 42 forms a fluid connection between the supply 35 and the heat outlet 36. When the first valve part 40 is in the first position, the coolness inlet 33 and the coolness outlet 37 are closed off by the second valve part 44 with respect to the discharge 34 and the supply 35. After all, the through-channels 45, 46 of the second valve part 44 are not aligned with respect to said discharge 34 and supply 35, but open out outside the coolness inlet 33, the coolness outlet 37, the supply 34 and the discharge 35. Warm water flows from the heat source 26 to the reactor 3 via the multiple-way valve 30, transfers heat to the silica gel and is returned to the heat source 26. The temperature of the warm water is well above the ambient temperature, for example between 50 and 95° C., such as 80° C.

When the silica gel in the reactor 3 has sufficiently evaporated, the drive shaft 48 rotates, with the valve parts 40, 44 fastened thereto, a quarter of a turn—from FIG. 3a to FIG. 3b—to the right. The valve parts 40, 44 are then in a heat recovery position. The coolness inlet 33 of the multiple-way valve 30 is in this case connected to the discharge 34 via the second through-channel 46 of the second valve part 44 for supplying cooling water to the reactor 3. The temperature of the cool water is slightly above the ambient temperature, for example between 25 and 40° C., such as 30° C.

At first, the heat exchange line 8 of the reactor and 3 still contains an amount of warm water which, in this heat recovery position, flows back to the heat source 26 via the supply 35, the first through-channel 41 of the first valve part 40 and the heat outlet 36. In this heat recovery position, the heat inlet 32 is closed off by the first valve part 40 with respect to the discharge 34 and the coolness outlet 37 is sealed by the second valve part 44 with respect to the supply 35.

Once the heat exchange line 8 in the reactor 3 is filled with cooling water, the drive shaft 48 is rotated, with the valve parts 40, 44 fastened thereto, a further quarter of a turn (see FIG. 3c). The first valve part 40 now has a second position in which the heat inlet 32 and the heat outlet 36 are sealed with respect to the discharge 34 and the supply 35. The through-channels 45, 46 of the second valve part 44 are in this case aligned with respect to the coolness inlet 33 and the discharge 34 and the supply 35 and the coolness outlet 37 respectively. In FIG. 3c, the reactor 30 is cooled and the silica gel in the reactor 30 absorbs water vapour from the evaporator 18.

Subsequently, the drive shaft 48 rotates the valve parts 40, 44 a further quarter of a turn toward the second heat recovery position shown in FIG. 3d. The amount of cooling water remaining in the heat exchange line 8 of the reactor 3 is in this case passed to the heat emitter 28 via the supply 35, the first through-channel 45 of the second valve part 44 and the coolness outlet 37. At the same time, the multiple-way valve 30 already conveys water from the heat source 26 to the reactor 3 via the heat inlet 32, the second through-channel 42 of the first valve part 40 and the discharge 34. The heat outlet 36 is in this case closed off by the first valve part 40 with respect to the supply 35, while the second valve part 44 closes off the coolness inlet 33 from the discharge 34.

When the cooling water has flowed away from the heat exchange line 8 of the reactor 3, the valve parts 40, 44 rotate a further quarter of a turn, so that the initial situation shown in FIG. 3a is reached again.

A second embodiment of a sorption cooling system according to the invention is represented in FIGS. 4, 5 and 6a-d. Like or similar components are indicated therein by like reference numerals.

This sorption cooling system 1 comprises a second reactor 73 (see FIG. 4) which is filled with silica gel and water bound thereto. Just like the reactor 3, the second reactor 73 comprises a supply 74 and a discharge 75 for water vapour. A heat exchange line 78 extends through the silica gel in the second reactor 73. The heat exchange line 78 runs from an inlet 76 to an outlet 77 of the second reactor 73.

The condenser 10 comprises a second supply 16 which is connected to the discharge 75 of the second reactor 73 via a vapour channel 94. A vapour valve, which prevents water vapour from flowing back from the condenser 10 to the second reactor 73 (check valve), is attached in the vapour channel 94 between the second supply 16 of the condenser 10 and the discharge 75 of the second reactor 73. Condensation of water vapour in the condenser 10 produces water (condensate) which flows out of the condenser 10 via the discharge 12. The water (condensate) is supplied to the supply 19 of the evaporator 18 via the return line 90 and the condensate valve 91.

In an embodiment (not shown), the condenser 10 has a second discharge for discharging water which is formed by condensation of water vapour in the condenser, while the evaporator 18 is provided with a second supply which is connected to the second discharge of the condenser 10. Water can then flow into the evaporator from the condenser via the second supply.

In the evaporator 18, the water (condensate) supplied via the supply 19 can evaporate by having a fluid flow through the heat exchange line 23. The evaporator 18 has a second discharge 25 for discharging water vapour. The second discharge 25 is connected to the supply 74 of the second reactor 73 by means of a vapour channel 95. A vapour valve 96, which prevents water vapour from flowing out of the second reactor 73 back to the evaporator 18, is attached in the vapour channel 95.

The sorption cooling system shown in FIG. 4 has a second refrigerant circuit in which the refrigerant—in this exemplary embodiment water/water vapour—can circulate. The functioning of the sorption cooling using the second refrigerant circuit of the second reactor 73 is the same as that described hereinbefore with reference to the first exemplary embodiment shown in FIG. 1. The batching processes in the first and second refrigerant circuit are operated, in the sorption cooling system shown in FIG. 4, in phase opposition in order to continuously produce cold.

The housing 31 of the multiple-way valve 30 has for this purpose a second discharge 65 and a second supply 64 (see in particular FIGS. 5, 6a-d). The housing 31 is also provided with two dividing pieces 66, 52. The first dividing piece 66 divides the heat inlet 32 into two mutually separated heat inlet channels 67, 68 and the heat outlet 36 into two mutually separated heat outlet channels 69, 70. Two mutually separated coolness inlet channels 53, 54 and two mutually separated coolness outlet channels 55, 56 are formed by means of the second dividing piece 52.

The second reactor 73 is cooled during the heating of the first reactor 3 (see FIG. 6a). The through-channels 41, 42 of the first valve part 40 connect the first heat inlet channel 67 and the first heat outlet channel 69 to the discharge 34 and the supply 35 which are connected to the first reactor 3. At the same time, the first valve part 40 closes off the second heat inlet channel 68 and the second heat outlet channel 70 with respect to the second discharge 65 and the second supply 64 which are connected to the second reactor 73. Said second discharge 65 and second supply 64 are in fluid connection to the second coolness inlet channel 54 and the second coolness outlet channel 56 of the second dividing piece 52 via the through-channels 45, 46 of the second valve part 44. The first coolness inlet channel 53 and the first coolness outlet channel 55 are closed off by the second valve part 44.

After the valve parts 40, 44 are rotated a quarter of a turn—in the drawing to the right—the heat recovery position represented in FIG. 6b is reached. At first, warm liquid is still present in the first reactor 3. For the recovery of heat, the first coolness inlet channel 53 of the second dividing piece 52 is connected to the discharge 34 to the first reactor 3 via the second through-channel 46 of the second valve part 44. The supply 35 from the first reactor 3 is still in fluid connection to the first heat outlet channel 69 via the first through-channel 41 of the first valve part 40. Operation therefore commences with cooling of the first reactor 3, while heat is still recovered from the return flow from the first reactor 3.

At the same time, the heating of the second reactor 73 begins by still recovering heat from the return flow from the second reactor 73. The second heat inlet channel 68 is for this purpose connected to the second discharge 65 to the second reactor 73 via the second through-channel 42 of the first valve part 40, while the return flow from said second reactor 73 flows to the second coolness outlet channel 56 via the second supply 64 and the first through-channel 45 of the second valve part 44. The first heat inlet channel 67 and the second heat outlet channel 70 are in this case closed off by the first valve part 40 and the first coolness outlet channel 55 and the second coolness inlet channel 54 are closed off by the second valve part 44.

Rotating the valve parts 40, 44 a further quarter of a turn produces the position shown in FIG. 6c, which is precisely the opposite of the position according to FIG. 6a. In FIG. 6c, by contrast, the first reactor 3 is cooled and the second reactor 73 is warmed up.

Subsequently, the valve parts 40, 44 reach, as a result of a further quarter of a turn, the second heat recovery position represented in FIG. 6d. The second heat recovery position is the opposite of the heat recovery position shown in FIG. 6b, i.e. the first reactor 3 is switched after heating while liquid flows back out of the first reactor 3 to the coolness outlet, while operation commences with cooling of the second reactor 73, heat being recovered by passing the return flow from the second reactor 73 still to the heat outlet.

The multiple-way valve according to the invention can be embodied in various ways. FIG. 7 shows an alternative embodiment of a multiple-way valve for use in the sorption cooling system with two reactors. Instead of two rotatable valve parts, this multiple-way valve has four translatory valve parts 60 which are each provided with six through-channels 61. The translatory valve parts 60 can for example be operated by electromagnets. With this multiple-way valve, the same operativeness is possible such as was described hereinbefore with reference to FIGS. 4, 5 and 6a-d.

The sorption cooling system according to the invention can be further extended by reactors. FIGS. 8a-d represent schematically a multiple-way valve for use in a sorption cooling system with four reactors. Like and similar components are indicated by like reference numerals.

The first dividing piece 66 of the housing 31 of the multi-way valve 30 divides the heat inlet into four mutually separated heat inlet channels 67a, 67b, 67c, 67d and four mutually separated heat outlet channels 69a, 69b, 69c, 69d. The second dividing piece forms from the coolness inlet four mutually separated coolness inlet channels 53a, 53b, 53c, 53d and four mutually separated coolness outlet channels 55a, 55b, 55c, 55d. Two additional discharges 134, 165 and two additional supplies 135, 164 are also provided that can bring the multiple-way valve into fluid connection with a third reactor 83 and a fourth reactor 84. As is represented in FIGS. 8a-h, a third valve part 85 is attached between, on the one hand, the supplies 35, 64 and discharges 34, 65 to the first reactor 3 and second reactor 73 and, on the other hand, the supplies 135, 164 and discharges 134, 165 to the third reactor 83 and the second reactor 84.

In FIG. 8a, the first reactor 3 is heated and the second reactor 73 is cooled, while the third reactor is preheated and the fourth reactor 84 is precooled. The preheating of the third reactor 83 takes place as a result of the fact that water flows out of the reactor 3 to the third reactor 83 via the supply 35, a conduit 200 of the third valve part 85 and the third discharge 134 and subsequently to the heat outlet channel 69d via the third supply 135 and the second through-channel 42 of the first valve part 40.

In FIG. 8b, the valve parts 40, 44, 85 are rotated through 45°—the valve parts 40, 44, 85 then have a heat recovery position. During the recovery of heat from the return flow of the reactor 3 and the second reactor 73, the flow ceases in relation to the third reactor 73 and the fourth reactor 84 as a result of the fact that the conduit 200 of the third valve part 85 joins the third discharge 134 and third supply 135 together and, at the same time, the fourth discharge 165 and the fourth supply 164 are connected to each other by the conduit 201 of the third valve part 85.

By rotating a further step of 45°, the valve parts 40, 44, 85 reach the position represented in FIG. 8c. The third reactor 83 is then heated and the fourth reactor 84 is cooled, while precooling of the first reactor 3 and preheating of the second reactor 73 occurs. FIG. 8e shows cooling of the first reactor 3, heating of the second reactor 73, precooling of the third reactor 83 and preheating of the fourth reactor 84. FIG. 8g shows cooling of the third reactor 83, heating of the fourth reactor 84, preheating of the first reactor 3 and precooling of the second reactor 73. FIGS. 8d, 8f and 8h show heat recovery positions of the valve parts 40, 44, 85.

The multiple-way valve according to this exemplary embodiment can, for that matter, be operated without heat recovery positions—the valve parts 40, 44, 85 then rotate through 90° between the positions shown in FIGS. 8a, 8c, 8e and 8g.

Although the multiple-way valve has been described in various embodiments for use in a sorption cooling system, these multiple-way valves are not limited thereto. The multiple-way valve according to the invention is suitable for use in any system in which heating and cooling must be carried out alternately. Systems of this type with one reactor, two reactors and four reactors are represented schematically in FIGS. 9, 10 and 11, in which like or similar components are indicated by like reference numerals.

The invention is not limited to the exemplary embodiments represented in the figures. The person skilled in the art can make various adaptations which fall within the scope of the invention. It should be noted that the multiple-way valve can for example also be embodied without a heat recovery position. The invention therefore also relates to a multiple-way valve comprising a housing which is provided with:
a heat inlet for letting in a warm liquid,
a coolness inlet for letting in a cool liquid,
a discharge for discharging liquid that has been let in,
a supply for returning to the multiple-way valve liquid that has been discharged from the multiple-way valve via the discharge,
a heat outlet for letting out returned liquid,
a coolness outlet for letting out returned liquid,
a first valve part which is movable between a first position, in which the heat inlet is in fluid connection to the discharge for letting through warm liquid from the heat inlet to the discharge, and a second position in which the heat inlet is closed off with respect to the discharge,
a second valve part which is movable between a first position, in which the coolness inlet is in fluid connection to the discharge for letting through cool liquid from the coolness inlet to the discharge, and a second position in which the coolness inlet is closed off with respect to the discharge.

1-17. (canceled)

18. A multiple-way valve comprising a housing comprising:
(a) a heat inlet for letting in a warm liquid,
(b) a coolness inlet for letting in a cool liquid,
(c) a first discharge for discharging liquid that has been let in,
(d) a supply for returning to the multiple-way valve liquid that has been discharged from the multiple-way valve via the first discharge,
(e) a heat outlet for letting out returned liquid,
(f) a coolness outlet for letting out returned liquid,
(g) a first valve part which is movable between a first position, in which the heat inlet is in fluid connection to the first discharge for letting through warm liquid from the heat inlet to the first discharge, and a second position in which the heat inlet is closed with respect to the first discharge, and
(h) a second valve part which is movable between a first position, in which the coolness inlet is in fluid connection to the first discharge for letting through cool liquid from the coolness inlet to the first discharge, and a second position in which the coolness inlet is closed with respect to the first discharge,
wherein the first and second valve parts have a first heat recovery position in which:
(i) the coolness inlet is in fluid connection to the first discharge via the second valve part for letting through cool liquid from the coolness inlet to the first discharge,
(ii) the heat inlet is closed by the first valve part with respect to the first discharge, and
(iii) the supply is in fluid connection to the heat outlet via the first valve part for letting through returned liquid from the supply to the heat outlet.

19. The multiple-way valve of claim 18, wherein the valve parts are each provided with two through-channels and
wherein, in the first position of the first valve part, the heat inlet and the first discharge are connected by the first through-channel of the first valve part and the supply and the heat outlet are connected by the second through-channel of the first valve part and
wherein, in the second position of the first valve part, the heat inlet and the heat outlet are closed by the first valve part with respect to the supply and the first discharge and
wherein, in the first position of the second valve part, the coolness inlet and the first discharge are connected by the first through-channel of the second valve part and the supply and the coolness outlet are connected by the second through-channel of the second valve part and
wherein, in the second position of the second valve part, the coolness inlet and the coolness outlet are closed by the second valve part with respect to the supply and the first discharge and
wherein, in the heat recovery position, the supply and the heat outlet are connected by the first through-channel of the first valve part and the heat inlet is closed by the first valve part with respect to the first discharge and wherein, in said heat recovery position, the coolness outlet is closed by the second valve part with respect to the supply and the first discharge and the coolness inlet are connected by the second through-channel of the second valve part.

20. The multiple-way valve of claim 18, wherein the valve parts have a second heat recovery position in which:
(i) the heat inlet is in fluid connection to the first discharge via the first valve part for letting through warm liquid from the heat inlet to the first discharge,
(ii) the coolness inlet is closed by the second valve part with respect to the first discharge, and
(iii) the supply is in fluid connection to the coolness outlet for letting through returned liquid from the supply to the coolness outlet.

21. The multiple-way valve of claim 20, wherein, in the second heat recovery position, the heat outlet is closed by the first valve part with respect to the supply and the first discharge and the heat inlet are connected by the second through-channel of the first valve part and, in said second heat recovery position, the supply and the coolness outlet are connected by the first through-channel of the second valve part and the coolness inlet is closed by the second valve part with respect to the first discharge.

22. The multiple-way valve of claim 18, wherein the first and second valve parts are connected to each other such that the first valve part has the first position when the second valve part has the second position and the first valve part has the second position when the second valve part has the first position.

23. The multiple-way valve of claim 18, wherein the housing further comprises:
(i) a second discharge for discharging liquid that has been let in and
(j) a second supply for returning to the multiple-way valve liquid that has been discharged from the multiple-way valve via the second discharge, and
wherein, in the first position of the first valve, the heat inlet is closed by the first valve part with respect to the second discharge and
wherein, in the second position of the first valve part, the heat inlet is in fluid connection to the second discharge via the first valve part for letting through warm liquid from the heat inlet to the second discharge and
wherein, in the first position of the second valve part, the coolness inlet is closed by the second valve part with respect to the second discharge and
wherein, in the second position of the second valve part, the coolness inlet is in fluid connection to the second discharge via the second valve part for letting through cool liquid from the coolness inlet to the second discharge.

24. The multiple-way valve of claim 23, wherein the housing further comprises:
(k) a third discharge for discharging liquid that has been let in,
(l) a third supply for returning to the multiple-way valve liquid that has been discharged from the multiple-way valve via the third discharge,
(m) a fourth discharge for discharging liquid that has been let in, and
(n) a fourth supply for returning to the multiple-way valve liquid that has been discharged from the multiple-way valve via the fourth discharge and
wherein, in the first and second position of the first valve part, the heat inlet is closed by the first valve part with respect to the third discharge and the fourth discharge and
wherein, in the first and second position of the second valve part, the coolness inlet is closed by the second valve part with respect to the third discharge and the fourth discharge and
wherein the first valve part has a third position in which the heat inlet is in fluid connection to the third discharge via the first valve part for letting through warm liquid from the heat inlet to the third discharge and
wherein the first valve part has a fourth position in which the heat inlet is in fluid connection to the fourth discharge via the first valve part for letting through warm liquid from the heat inlet to the fourth discharge and
wherein the second valve part has a third position in which the coolness inlet is in fluid connection to the third discharge via the second valve part for letting through cool liquid from the coolness inlet to the third discharge and
wherein the second valve part has a fourth position in which the coolness inlet is in fluid connection to the fourth discharge via the second valve part for letting through cool liquid from the coolness inlet to the fourth discharge and
wherein the housing of the multiple-way valve is provided with a third valve part which is movable between a first position, in which the supply is in fluid connection to the third discharge via the third valve part and the second supply is in fluid connection to the fourth discharge via the third valve part, and a second position, in which the fourth supply is in fluid connection to the discharge via the third valve part and the third supply is in fluid connection to the second discharge via the third valve part, and a first heat recovery position, in which the fourth discharge is in fluid connection to the fourth supply via the third valve part and the third discharge is in fluid connection to the third supply via the third valve part, and a second heat recovery position in which the discharge is in fluid connection to the supply via the third valve part and the second discharge is in fluid connection to the second supply via the third valve part.

25. The multiple-way valve of claim 23, wherein the housing further comprises:
(o) a first dividing piece which divides the heat inlet into two heat inlet channels and divides the heat outlet into two heat outlet channels, and
(p) a second dividing piece which divides the coolness inlet into two coolness inlet channels and divides the coolness outlet into two coolness outlet channels,
wherein, in the first position of the first valve part, the first heat inlet channel of the first dividing piece and the discharge are connected by the first through-channel of the first valve part and the supply and the first heat outlet channel of the first dividing piece are connected by the second through-channel of the first valve part and the second heat inlet channel and the second heat outlet channel of the first dividing piece are closed by the first valve part and
wherein, in the second position of the first valve part, the second heat inlet channel of the first dividing piece and the second discharge are connected by the first through-channel of the first valve part and the second supply and the second heat outlet channel of the first dividing piece are connected by the second through-channel of the first valve part and the first heat inlet channel and the first heat outlet channel of the first dividing piece are closed by the first valve part and
wherein, in the first position of the second valve part, the first coolness inlet channel of the second dividing piece and the discharge are connected by the first through-channel of the second valve part and the supply and the first coolness outlet channel of the second dividing piece are connected by the second through-channel of the second valve part and the second coolness inlet channel and the second coolness outlet channel of the second dividing piece are closed by the second valve part and
wherein, in the second position of the second valve part, the second coolness inlet channel of the second dividing piece and the second discharge are connected by the first through-channel of the second valve part and the second supply and the second coolness outlet channel of the second dividing piece are connected by the second through-channel of the second valve part and the first coolness inlet channel and the first coolness outlet channel of the second dividing piece are closed by the second valve part and
wherein, in the heat recovery position, the supply and the first heat outlet channel of the first dividing piece are connected by the first through-channel of the first valve part and the second heat inlet channel of the first dividing piece and the second discharge are connected by the second through-channel of the first valve part and, in said heat recovery position, the second supply and the second coolness outlet channel of the second dividing piece are connected by the first through-channel of the second valve part and the discharge and the first coolness inlet channel of the second dividing piece are connected by the second through-channel of the second valve part.

26. The multiple-way valve of claim 25, wherein, in the second heat recovery position:
(i) the second supply and the second heat outlet channel of the first dividing piece are connected by the first through-channel of the first valve part and the first heat inlet channel of the first dividing piece and the discharge are connected by the second through-channel of the first valve part, and
(ii) the supply and the first coolness outlet channel of the second dividing piece are connected by the first through-channel of the second valve part and the second discharge and the second coolness inlet channel of the second dividing piece are connected by the second through-channel of the second valve part.

27. The multiple-way valve of claim 18, wherein the first and/or second valve parts are attached within the housing of the multiple-way valve so as to be rotatable with respect to the axis of rotation.

28. The multiple-way valve of claim 27, wherein the first and/or second valve parts are fastened to a common drive shaft operable by a stepping motor.

29. A system for alternately cooling and heating a reactor, comprising:
(a) a reactor with an inlet and an outlet,
(b) a heat source,
(c) a heat emitter, and
(d) a multiple-way valve according to claim 18,
wherein the heat inlet and the heat outlet of the multiple-way valve are connected to the heat source,
wherein the coolness inlet and coolness outlet of the multiple-way valve are connected to the heat emitter,
wherein the discharge of the multiple-way valve is connected to the inlet of the reactor, and
wherein the outlet of the reactor is connected to the supply of the multiple-way valve.

30. The system of claim 29, wherein the housing further comprises:
(i) a second discharge for discharging liquid that has been let in and
(j) a second supply for returning to the multiple-way valve liquid that has been discharged from the multiple-way valve via the second discharge, and
wherein, in the first position of the first valve, the heat inlet is closed by the first valve part with respect to the second discharge and
wherein, in the second position of the first valve part, the heat inlet is in fluid connection to the second discharge via the first valve part for letting through warm liquid from the heat inlet to the second discharge and
wherein, in the first position of the second valve part, the coolness inlet is closed by the second valve part with respect to the second discharge,
wherein, in the second position of the second valve part, the coolness inlet is in fluid connection to the second discharge via the second valve part for letting through cool liquid from the coolness inlet to the second discharge, and
wherein a second reactor with an inlet and an outlet is provided and wherein the second discharge of the multiple-way valve is connected to the inlet of the second reactor and the outlet of the second reactor is connected to the second supply of the multiple-way valve.

31. The system of claim 29, wherein the housing further comprises:
(k) a third discharge for discharging liquid that has been let in,
(l) a third supply for returning to the multiple-way valve liquid that has been discharged from the multiple-way valve via the third discharge,
(m) a fourth discharge for discharging liquid that has been let in, and
(n) a fourth supply for returning to the multiple-way valve liquid that has been discharged from the multiple-way valve via the fourth discharge and
wherein, in the first and second position of the first valve part, the heat inlet is closed by the first valve part with respect to the third discharge and the fourth discharge and
wherein, in the first and second position of the second valve part, the coolness inlet is closed by the second valve part with respect to the third discharge and the fourth discharge and
wherein the first valve part has a third position in which the heat inlet is in fluid connection to the third discharge via the first valve part for letting through warm liquid from the heat inlet to the third discharge and
wherein the first valve part has a fourth position in which the heat inlet is in fluid connection to the fourth discharge via the first valve part for letting through warm liquid from the heat inlet to the fourth discharge and
wherein the second valve part has a third position in which the coolness inlet is in fluid connection to the third discharge via the second valve part for letting through cool liquid from the coolness inlet to the third discharge and
wherein the second valve part has a fourth position in which the coolness inlet is in fluid connection to the fourth discharge via the second valve part for letting through cool liquid from the coolness inlet to the fourth discharge,
wherein the housing of the multiple-way valve is provided with a third valve part which is movable between a first position, in which the supply is in fluid connection to the third discharge via the third valve part and the second supply is in fluid connection to the fourth discharge via the third valve part, and a second position, in which the fourth supply is in fluid connection to the discharge via the third valve part and the third supply is in fluid connection to the second discharge via the third valve part, and a first heat recovery position, in which the fourth discharge is in fluid connection to the fourth supply via the third valve part and the third discharge is in fluid connection to the third supply via the third valve part, and a second heat recovery position in which the discharge is in fluid connection to the supply via the third valve part and the second discharge is in fluid connection to the second supply via the third valve part, and
wherein a second, third and fourth reactor each with an inlet and an outlet are provided and wherein the second, third and fourth discharge of the multiple-way valve are connected to the inlet of respectively the second, third and fourth reactor and the outlet of the second, third and fourth reactor is connected to respectively the second, third and fourth supply of the multiple-way valve.

32. A sorption cooling system comprising:
(a) a multiple-way valve according to claim 18,
(b) a reactor with a sorbent and a refrigerant, which reactor is provided with:
(i) a supply for vaporous refrigerant,
(ii) a discharge for vaporous refrigerant,
(iii) an inlet,
(iv) an outlet, and
(v) a heat exchange line extending through the sorbent and the refrigerant in the reactor from the inlet to the outlet of the reactor,
wherein the discharge is connected to the inlet of the reactor and the outlet of the reactor is connected to the supply of the multiple-way valve,
(c) a condenser provided with:
(i) a supply for vaporous refrigerant connected to the discharge of the reactor,
(ii) a discharge for refrigerant condensed in the condenser,
(iii) an inlet for cool liquid,
(iv) an outlet for cool liquid, and
(v) a heat exchange line extending in the condenser from the inlet to the outlet of the condenser, the outlet for cool liquid of the condenser being connected to the coolness inlet of the multiple-way valve,
(d) an evaporator provided with:
(i) a supply for liquid refrigerant that is connected to the discharge of the condenser,
(ii) a discharge for refrigerant evaporated in the evaporator that is connected to the supply of the reactor,
(iii) an inlet for cold fluid,
(iv) an outlet for cold fluid and a heat exchange line extending in the evaporator from the inlet to the outlet of the evaporator,
(e) a heat source which is connected to the heat inlet and the heat outlet of the multiple-way valve, and
(f) a heat emitter which is connected to the coolness outlet of the multiple-way valve and to the inlet for cool liquid of the condenser.

33. The sorption cooling system of claim 32, wherein the housing further comprises:
(i) a second discharge for discharging liquid that has been let in and
(j) a second supply for returning to the multiple-way valve liquid that has been discharged from the multiple-way valve via the second discharge, and
wherein, in the first position of the first valve, the heat inlet is closed by the first valve part with respect to the second discharge and
wherein, in the second position of the first valve part, the heat inlet is in fluid connection to the second discharge via the first valve part for letting through warm liquid from the heat inlet to the second discharge and
wherein, in the first position of the second valve part, the coolness inlet is closed by the second valve part with respect to the second discharge,
wherein, in the second position of the second valve part, the coolness inlet is in fluid connection to the second discharge via the second valve part for letting through cool liquid from the coolness inlet to the second discharge, and
wherein the sorption cooling system is provided with a second reactor with a sorbent and a refrigerant, which second reactor is provided with a supply for vaporous refrigerant, a discharge for vaporous refrigerant, an inlet, an outlet and a heat exchange line extending through the sorbent and the refrigerant in the second reactor from the inlet to the outlet of said second reactor, the second discharge of the multiple-way valve being connected to the inlet of the second reactor and the outlet of the second reactor being connected to the second supply of the multiple-way valve,
the condenser being provided with a second supply for vaporous refrigerant that is connected to the discharge of the second reactor,
the evaporator being provided with a second discharge for refrigerant evaporated in the evaporator that is connected to the supply of the second reactor.

34. The sorption cooling system of claim 32, wherein the housing further comprises:
(k) a third discharge for discharging liquid that has been let in,
(l) a third supply for returning to the multiple-way valve liquid that has been discharged from the multiple-way valve via the third discharge,
(m) a fourth discharge for discharging liquid that has been let in, and
(n) a fourth supply for returning to the multiple-way valve liquid that has been discharged from the multiple-way valve via the fourth discharge and
wherein, in the first and second position of the first valve part, the heat inlet is closed by the first valve part with respect to the third discharge and the fourth discharge and
wherein, in the first and second position of the second valve part, the coolness inlet is closed by the second valve part with respect to the third discharge and the fourth discharge and
wherein the first valve part has a third position in which the heat inlet is in fluid connection to the third discharge via the first valve part for letting through warm liquid from the heat inlet to the third discharge and
wherein the first valve part has a fourth position in which the heat inlet is in fluid connection to the fourth discharge via the first valve part for letting through warm liquid from the heat inlet to the fourth discharge and
wherein the second valve part has a third position in which the coolness inlet is in fluid connection to the third discharge via the second valve part for letting through cool liquid from the coolness inlet to the third discharge and
wherein the second valve part has a fourth position in which the coolness inlet is in fluid connection to the fourth discharge via the second valve part for letting through cool liquid from the coolness inlet to the fourth discharge and
wherein the housing of the multiple-way valve is provided with a third valve part which is movable between a first position, in which the supply is in fluid connection to the third discharge via the third valve part and the second supply is in fluid connection to the fourth discharge via the third valve part, and a second position, in which the fourth supply is in fluid connection to the discharge via the third valve part and the third supply is in fluid connection to the second discharge via the third valve part, and a first heat recovery position,
